(19) United States
(12) Patent Application Publication
(10) Pub. No.: US 2021/0067708 A1
(43) Pub. Date: Mar. 4, 2021

(54) TechnologyNP

(71) Applicant: JonMichael Harmon, Arcata, CA (US)

(72) Inventor: JonMichael Harmon, Arcata, CA (US)

(21) Appl. No.: 17/005,830

(22) Filed: Aug. 28, 2020

Related U.S. Application Data
(60) Provisional application No. 62/893,648, filed on Aug. 29, 2019.
(60) Provisional application No. 62/953,748, filed on Dec. 26, 2019.
(60) Provisional application No. 63/063,261, filed on Aug. 8, 2020.

(51) Int. Cl. H04N 5/247; G06Q 50/00; H04N 5/225; G06F 3/041; G06F 3/0481; H04R 1/10; G06F 3/16; G06T 11/00; H04M 1/725; H04L 12/58

(52) U.S. Cl. CPC H04N 5/247; G06Q 50/01; H04N 5/2257; G06F 3/041; G06F 3/04817; H04R 1/1016; B60J 7/085; G06F 3/165; G06T 11/00; H04M 1/725; H04L 51/32; H04R 2420/07; G06T 2210/22; H04R 1/1041

(57) ABSTRACT

This nonprovisional patent application pertains to technological devices. Devices that will be discussed and claimed pertain to wireless headphones, smartphone features, social media app features, navigational app features, and an electronic truck bed closure system.

### BACKGROUND OF INVENTION

Previous to my provisional application smartphones have been made with two or three cameras on the rear of the phone. Rear meaning non-screen side of the phone. Such phones include Galaxy, Samsung, Google and Apple phones. On the front side of the phone, screen phone, two cameras have been placed for better selfie taking.

Previous to my provisional application lnstagram had a limited time post system called a story. People where able to share other peoples post on their story however it did not play automatically when the shared post was a video. To watch the video, users must go to the page of the account that posted the video.

Previous to my provisional application Apple had release their air pods which had a touch responsive surface system; however, volume and song control was available with swiping. Other companies have release waterproof wireless headphones; however, they do not include touch responsive surface.

Navigational apps have been made that show multiple lanes of traffic on the side of the road that the user's vehicle is not driving on. Navigational apps have shown multiple lanes of traffic on the side that the user's vehicle is driving on but only as the lanes begin to merge, or exit. Navigational apps have been made with an arrow like icon to depict the location and direction of the user's vehicle on the map.

A truck bed closure system has been made where the cover rolls out to cover the truck bed. However, this truck bed cover is a separate apparatus and is separate from the truck. The customer must buy the cover separately and install it.

Previous to my provisional application apps have been made where you can design a custom icon to look like you or however you want. This user designed icon can than have app generated variations where the icon can be expressing different moves and have different backgrounds. Other apps have taken images of a persons face an added a body and background.

### SPECIFICATION

To make a smart phone able to take better photos, four or more cameras can be placed on the backside of the phone. Some of the cameras can specialize in close focus and other can specialize in long distance. Behind each of the cameras is wires that are moveable for optical stabilization. Behind the optical stabilization is the image sensor where a multicolored filter is used to create the colored images which is connected to the electronic component, however the image sensor can be placed adjacent to the cameras where all the cameras on that side of the phone can be digitally connected to that image sensor. The hardware component of the cameras can be adjacent to each of the cameras or adjacent to the image sensor.

A social media app where people can post personal photos and videos as well as share other's posts. On the top portion of the app can have a horizontal list of limited time posts. These posts can only be viewed by other accounts for 24 hours or until the user who posted it decides to delete it. As a user browses through said social media app they may find a most they would like to report for a limited time. An icon at the bottom of the post can allow the user to send it to other accounts or for them to post it for a limited time. When a user posts a shared video for a limited time the video can play automatically or when a play icon is selected. So when another user view the limited time post they are able to watch part or all of the video from that window. If the post that was shared had multiple images or videos the viewer of the shared post can be able to swipe through the images and videos on that window.

A pair of wireless music pods, where pods are described as separate units that are not physically connected. Said music pods can have a surface tap pattern where the volume, pausing, and song order can be controlled. This can be done adding a surface layer of touch screen on part of the headphone. This touch screen layer is then connected to the internal hardware of the music pod where the commands can be processed, and the proper feedback can be given. This device can be waterproof as well, this can be done in a variety of way. Giving the device a coating of silicon, manufacturing a tight construction where cracks between parts are made extremely small and even sealing these cracks with a glue-like material. Water-proof casing can be made to cover the device or just to cover the speaker area. A thin plastic layer can be heat shrunk around the device.

A navigational app can show multiple lanes on the road your vehicle is traveling in the direction your vehicle is traveling. This helps the driver see exactly what lane they are in and what lane/s they need to be in if an exit is coming up. This can be done by the app by collecting information on the number of lanes of roads across the country or even possibly the world. This information would than be entered into the app, so that the users can see this information. To better show the direction of your travel a vehicle can depict your location on the map. The vehicle can point in the direction of your orientation. This can be done by creating a vehicle icon and replacing the old icon with the vehicle icon.

A self-expressing feature on a social media app or texting interface can use a face scan or an image to create a cartoonish or specifically altered symbol. This can be done by having the user take an image or face scan. The app then takes this information and runs it through an algorithm that alters it. The algorithm can alter the original by simplifying one's face, making it look cartoonish, or by just cropping around the face. This altered image or face scan can then be made into a variety of different icons. By running another algorithm, a variety of different icons can be made with a variety of different expressions, actions and backgrounds. These icons can then be available for user near the keyboard. These icons can be used to be put on images and videos, as well as to fit uniformly on a line of text.

1. Smartphone comprising multiple cameras.
a. Said smartphone can have four to seven cameras on the back of the phone.
b. Said smartphone with three or more cameras on a face of the phone that has a touch screen.

2. Social media platform where post can be shared for limited amounts of time.
a. Said social media platform can have a shared post for a limited amount of time where if the shared post is a video it can be played automatically or when a play icon is selected.

3. A wireless music pods with a touch responsive surface system.
a. Said music pods can have volume control from surface touch pattern.
b. Said music pods can have song order control for surface swipe pattern.
c. Said music pods can be paused from single tap.
d. Said music pods can be made waterproof.

4. Navigation app that shows map of roads.
a. Said navigational app can show multiple lanes on the road your vehicle is traveling in the direction your vehicle is traveling.
b. Said navigational app can depict where you are by showing a symbol of a vehicle on the map where your current location is approximately.

5. A truck with truck bed closure system.
a. Said truck can have a cover for the truck bed is built into the truck where the cover can roll out for usage.

6. A self-expressing feature on a social media app or texting interface can use a face scan or an image to:
a. Create a cartoonish or specifically altered symbol
i. Said symbol can than be altered into expressing different emotions and actions or have different backgrounds.
b. Crop your face onto a background that can express emotions, activities and more.
